(19) United States
(12) Patent Application Publication
(10) Pub. No.: US 2003/0009929 A1
(43) Pub. Date: Jan. 16, 2003

(54) Composition and method of making a combustible organic mixture used to generate a colorful flame

(76) Inventors: Gary L. Newton, San Jose, CA (US); Javad J. Sahbari, Mill Valley, CA (US)

Correspondence Address: OPPENHEIMER WOLFF & DONNELLY, P. O. BOX 10356, PALO ALTO, CA, 94303, US

(21) Appl. No.: 10/196,828

(22) Filed: Jul. 16, 2002

Related U.S. Application Data
(60) Provisional application No. 60/305,918, filed on Jul. 16, 2001.

(51) Int. Cl. C10L 5/00; C11C 5/00; C10L 10/00; C10L 1/18; C10L 7/00; C01B 3/32

(52) U.S. Cl. 44/275; 44/642; 44/385; 48/127.3

(57) ABSTRACT

Composition and method of making a combustible organic mixture used to generate a colorful flame that is environmentally safe and non toxic. In accordance with the invention there is provided a fuel blend mixture of hydrocarbons, alcohols, glycols or glycol ethers with a color flame generator in the form of an organometallic complex such as acetyl acetonate complexes of alkaline, alkaline earth or transition metals such as lithium, cesium, sodium, and copper acetyl acetonate complexes. The homogenous material can be used as a fuel in various types of candles and lantern devices to generate flames of red, yellow, blue, green or purple color and variations thereof depending on the organometallic complex that is used.

### RELATED APPLICATIONS

This application claims the benefit of U.S. Provisional Application No. 60/305,918, filed Jul. 16, 2001 and entitled Colored Flame Compositions, the entire contents of such application being expressly incorporated herein by reference.

### FIELD OF THE INVENTION

The present invention relates to compositions of combustible organic formulations that can be used to generate homogenous streams of flame when ignited. More specifically, the present invention relates to compositions including environmentally safe organic solvent mixtures and at least one organometallic additive that when ignited generate a flame having a predictable color (e.g., green, red, violet, orange, blue or yellow). The combustible media may be in the form of a liquefied gas, a liquid, a gel, or a solid depending upon its chemical composition and the nature of the additives.

### DISCUSSION OF THE PRIOR ART

Various types of wax and wick-fed liquid candles have been used as sources of light for hundreds of years. Candles made from a variety of materials such as waxes, hydrocarbons, colorants and odorants or perfumes have been used to obtain a desirable odor or scent. And certain oils and fragrances having particular aromas have been added to combustible products used as incense and to provide aromatherapy. In addition, certain compositions have been added to liquid and solid combustible products and used to repel insects, kill odors and suppress mildew. Various menthol oils have also been added to products used to treat respiratory discomfort. However, to Applicant's knowledge no one has to date provided formulations that can be added to liquefied gases, liquids, gels, and wax materials for the purpose of generating flames having specific coloration for entertaining and mood setting applications.

### SUMMARY OF THE INVENTION

It is therefore an objective of the present invention to provide methods of developing novel compositions that can be used in gas, liquid and solid form to generate predictable colored light as a result of combustion of the material.

Briefly the present invention relates to the provision of organic compositions including environmentally safe and non toxic, combustible mixtures of fuel blend such as saturated hydrocarbons, high boiling point alcohols, glycols, glycol ethers, waxes and paraffins, plus an organometallic complex of a color generating metal or color flame generator/additive which is miscible with such fuel blend. In accordance with the invention there is provided a fuel blend mixture of hydrocarbons, alcohols, glycols or glycol ethers with a color flame generator in the form of an organometallic complex such as acetyl acetonate complexes of alkaline, alkaline earth or transition metals such as lithium, cesium, sodium, and copper acetyl acetonate complexes. The homogenous material can be used as a fuel in various types of candles and lantern devices to generate flames of red, yellow, blue, green or purple color and variations thereof depending on the metal complex that is used.

Among the advantages of the present invention is that it provides new compositions from which special purpose lighting and mood lighting apparatus can be made, including for example, solid paraffin based candles, refillable liquid wick-fed restaurant style candles, tiki torches, flash paper for magicians acts, etc. Compositions provided in accordance with the present invention can also be applied to firelog material to produce fireplace colors. More specifically, by utilizing different color compositions in adjacent or concentric layers of fireplace log material separated by paraffin or using waxed paper separators, multicolored and changing color flames can be obtained for use in fireplace log applications. In addition, by injecting compositions in accordance with the present invention into gas streams feeding indoor or outdoor lighting apparatus, a series of color changes can be effected as desired to suit particular purposes.

### DETAILED DESCRIPTION OF THE PREFERRED EMBODIMENTS

As indicated above the present invention can be practiced in embodiments encompassing gas, liquefied gas, liquid, gel and solid forms.

Liquid Fuel Embodiment:

The liquid composition of the present invention contains an organometallic complex of a color flame generating metal ion such as cesium, lithium, sodium, copper acetyl acetonate dissolved in a polar organic solvent such as a propylene glycol ether or a high boiling point alcohol such of n-heptanol or hexanol and mixed with high molecular weight

aliphatic hydrocarbons such as mineral spirit or petroleum naphta. Other non-toxic combustible materials such as hydrocarbon mixtures, mineral oil, waxes, paraffins, also may be used as the fuel blend. The resulting color depending on the type of metal ion complex used will be due to the ionization of the alkaline, alkaline earth or transition metal ion and when burned will generate a visually colorful flame which is continuous, liquid and long lasting.

The novel composition is comprised a mixture of

A. From about 1% by weight to about 10% wt of an organometallic additive such as lithium, sodium, copper, cesium, potassium, strontium acetylacetronate which is soluble in or miscible with an organic polar solvent.

B. From about 5% by weight to about 55% wt of an organic polar solvent such as high boiling point alcohol, glycol or glycol ether.

C. From about 5% wt. to about 65% wt. of a hydrocarbon mixture, paraffin, wax, aliphatic or olefinic hydrocarbon such as odorless mineral spirits or petroleum naphtha.

The hydrocarbons suitable for use in this invention are odorless mineral spirits (OMS), petroleum naphtha, Aliphatic hydrocarbon mixtures of 8 to 15 carbon atoms, and alpha-olefins of 8 to 16 carbon atoms such as golftenes. These materials are commercially available from Ashland Oil and Chemical Co., Chevron Chemicals, Philips Petroleum and Chemicals companies.

Among the organic polar solvents, the suitable alcohols or glycols for this composition include n-pentanol, n-hexananol, n-heptanol, or diols such as 1,3-propane diol, 1,3-butane diol, 1,3-pentane diol. Such solvents are readily available from Aldrich Chemical Company of Milwaukee, Wis.

The suitable organometallic complexes of acetylacetonates used in accordance with this invention are cesium acetylacetonate, lithium acetylacetonate, copper acetylacetonate and calcium, strontium or sodium acetyl acetonates. Such materials are readily available from Aldrich Chemical Co. of Milwaukee, Wis.

### EXAMPLE A1:

7.5 grams of Copper Acetyl acetonate was dissolved in 32.5 grams of Glycol Ether PM (propylene glycol monomethyl ether) to form an organic mixture. 60 grams of Odorless Mineral Spirit (OMS) was weighed in a 500 ml erlen meyer flask. The organic mixture was then added to the hydrocarbon mixture OMS. The resulting mixture was stirred to form a homogeneous uniform colorless liquid. This mixture was used as liquid candle fuel in a glass container with a cotton string inserted in the middle. The candle was ignited and generated a bluish green color flame.

### EXAMPLE A2

5 grams of Cesium Acetyl acetonate was dissolved in 25 grams of Glycol Ether PM (propylene glycol monomethyl ether) to form an organic mixture. 70 grams of Odorless Mineral Spirit (OMS) was weighed in a 500 ml erlen meyer flask. The organic mixture was then added to the hydrocarbon mixture OMD. The resulting mixture was stirred to form a homogeneous uniform colorless liquid. This mixture was used as liquid candle fuel in a glass container with a cotton string. The candle was ignited and generated a uniform purple red color flame.

### EXAMPLE A3

4 grams of lithium Acetylacetonate was dissolved in 26 grams of Glycol Ether PM (propylene glycol monomethyl ether) to form an organic mixture. 70 grams of petroleum naphtha (odorless naphtha) was weighed in a 500 ml erlen meyer flask. The organic mixture was then added to the hydrocarbon mixture OMS. The resulting mixture was stirred to form a homogeneous uniform colorless liquid. This mixture was used as liquid candle fuel in a glass container with a cotton string. The candle was ignited and generated a uniform purple red color flame.

Liquefied Gas Embodiment:

The novel composition of the present invention is comprised a mixture of

A. From about 1% by weight to about 10% wt. of an organometallic additive such as lithium, sodium, copper, cesium, potassium, strontium acetylacetronate which is soluble in or miscible with an organic polar solvent.

B. From about 5% by weight to about 55% wt of an organic polar solvent such as high boiling point alcohol, glycol or glycol ether.

C. From about 5% wt. to about 75% wt. of a low boiling hydrocarbon mixture, commercially available natural gas mixture such as propane, butane pentane, hexane or a mixture thereof.

The hydrocarbons suitable for use in this invention are saturated aliphatic hydrocarbons of 3-6 carbon atoms, with a general formula CnH2n+2 where n is an integer number 3 to 6 (such as propane, butane, pentane or hexane). These materials are commercially available from Ashland Oil and Chemical Co., Chevron Chemicals, Philips Petroleum and Chemicals companies.

Among the organic polar solvents, suitable alcohols or glycols for this composition are such as n-pentanol, n-hexananol, n-heptanol, or diols such as 1,3-propane diol, 1,3butane diol, 1,3-pentane diol and are readily available from Aldrich Chemical Company of Milwaukee, Wis.

The suitable organometallic complexes of acetylacetonates used in accordance with this invention are cesium acetylacetonate, lithium acetylacetonate, copper acetylacetonate and calcium, strontium or sodium acetylacetonates are readily available from Aldrich Chemical Co. of Milwaukee, Wis.

In order to make the liquefied gas embodiment, the organometallic complex material is first dissolved in the organic polar solvent to form an organic mix. The liquefied gas is then cooled in a dry ice bath in a stainless steel container to bring it below its boiling point. The organic mix is also cooled to below hydrocarbons boiling point and then added to the liquid gas at lower temperature. The material is injected into a lighter container and used as a cigarette lighter or the like.

### EXAMPLE B1

4 grams of lithium acetyl acetonate was dissolved in 16 grams of glycol ether PM (propylene glycol monomethyl ether) to form an organic mixture. 80 grams of pentane gas was cooled in a 250 ml stainless steel container in a dry ice bath to keep it cold in liquid form. The organic mixture was also cooled to below hydrocarbons boiling point and then was added to the pentane liquid and mixed to dissolve completely to form a uniform liquid. The resulting mixture was then cooled further down and injected into a cigarette lighter container. The lighter was then tested and ignited and a red color flame was produced.

### EXAMPLE B2

3 grams of copper acetyl acetonate was dissolved in 17 grams of isopropyl alcohol (IPA) to form an organic mixture. 80 grams of pentane gas was cooled in a 250 ml stainless steel container in a dry ice bath to keep it cold in liquid form. The organic mixture was also cooled to below hydrocarbons boiling point and then was added to the pentane liquid and mixed to dissolve and completely form a uniform liquid. The resulting mixture was then cooled further down and injected into a cigarette lighter container. The lighter was then tested and ignited and a greenish blue color flame was produced.

### EXAMPLE B3

4 grams of lithium acetylacetonate and 2 grams of potassium acetylacetonate were dissolved in 14 grams of ethyl alcohol (ethanol) to form an organic mixture. 80 grams of butane gas was cooled in a 150 ml stainless steel container in a dry ice bath to keep it cold in liquid form. The organic mixture was also cooled to below hydrocarbons boiling point and then was added to the butane liquid and mixed to dissolve completely to form a uniform liquid. The resulting mixture was then cooled further down and injected into a cigarette lighter container. The lighter was then tested and ignited and a pinkish red color flame was produced.

Solid Wax Embodiment

The novel composition of the present invention is comprised a mixture of

A: From about 1% by weight to about 10% wt. of an organometallic additive such as lithium, sodium, copper, cesium, potassium, strontium acetylacetonate complex which is soluble in or miscible with the organic polar solvent used in this invention.

B. From about 2% by weight to about 20% by weight of an organic polar solvent such as high boiling point alcohol, ethylene propylene glycols and ethylene or propylene glycol ethers.

C. From about 5% wt. to about 95% wt. of a synthetic, animal derived or plant derived wax such as bees wax, paraffin wax, whale wax or any other natural or synthetic wax material with a chemical formula of CH3(CH2)nCOO(CH2)mCH3, where m and n are integer numbers, that are naturally solid at ambient temperature but have a low melting point and can be melted to liquid from at elevated temperature.

The waxes suitable for use in this invention are those that are used in candle manufacturing such a paraffin wax, bees wax, carnowa wax, and so on. These materials are commercially available from Aldrich Chemical Co. of Milwaukee, Wis.

Among the organic polar solvents, the suitable alcohols or glycols for this composition are such as n-pentanol n-hexananol, n-heptanol, or diols such as 1,3-propane diol, 1-3 butane diol, 1,3-pentane diol are readily available from Aldrich Chemical Company of Milwaukee, Wis.

The suitable organometallic complexes of acetylacetonates used in accordance with this invention are cesium acetylacetonate, lithium acetylacetonate, copper acetylacetonate and calcium, strontium or sodium acetylacetonates are readily available from Aldrich Chemical Co. of Milwaukee, Wis.

In order to make the preferred solid embodiment, the organometallic complex agent is first dissolved in the organic polar solvent to form a homogeneous liquid mixture (organic mixture). The wax material is then melted in a Pyrex glass beaker on the hot plate, and once melted completely, the organic mixture is added to the melted wax and stirred to form a homogeneous mixture on the hot plate. The candle mixture then is cooled to room temperature to form a solid candle using a desired shape and form.

### EXAMPLE C1

4 grams of Lithium Acetyl acetonate was dissolved in 16 grams of Glycol Ether DPM (dipropylene glycol monomethyl ether) to form an organic mixture. 80 grams of paraffin wax was heated in a 400 ml beaker on a hot plate to melt completely and form a liquid. The organic mixture was then added to the melted paraffin and stirred to dissolve and mix completely to for a uniform liquid. The resulting mixture was cooled down to form a soft waxy solid material and several candles of different shape and forms were made using 100% cotton string and allowed to cool down to room temperature. The candles were then lighted and a red color flame was produced.

### EXAMPLE C2

5 grams of copper Acetyl acetonate was dissolved in 15 grams of Glycol Ether TPM (tripropylene glycol monomethyl ether) to form an organic mixture. 80 grams of paraffin wax was heated in a 400 ml beaker on a hot plate to melt completely and form a liquid. The organic mixture was then added to the melted paraffin and stirred to dissolve and mix completely to form a uniform liquid. The resulting mixture was cooled down to form a soft waxy solid material and several candles of different shape and form was made using 100% cotton string and allowed to cool down to room temperature. The candle was then lighted and a greenish blue color flame was produced.

### EXAMPLE C3

5 grams of Potassium Acetyl acetonate was dissolved in 15 grams of glycol ether DPM (diprophylene glycol monomethyl ether) to form an organic mixture. 80 grams of paraffin wax was heated in a 400 ml beaker on a hot plate to melt completely and form a liquid. The organic mixture was then added to the melted paraffin and stirred to dissolve and mix completely to form a uniform liquid. The resulting mixture was cooled down to form a soft waxy solid material and several candles of different shape and form were made using 100% cotton string and allowed to cool down to room temperature. The candles were then lighted and a purple/blue color flame was produced.

Although the examples given in this disclosure are specific examples of preferred embodiments of liquid, liquefied gas, and solid wax media examples for color flame compositions, after having read the disclosure it will be apparent to those who are familiar with the art that one can add additional color additives, odorants, gel formation additives or viscosity modifiers to change the color, odor or viscosity and physical property of the color flame generating material. It is therefore intended that the several examples be considered illustrative and not limiting, and that the following claims be interpreted broadly as covering all alterations, modifications and other embodiments as fall within the true spirit and scope of the invention.

What is claimed is:

1. A composition of combustible matter, comprising:
an organometallic material dissolved in an organic polar solvent and mixed with a hydrocarbon fuel to produce a mixture that when ignited develops a flame having a predetermined color.

2. A composition of combustible matter as recited in claim 1 wherein said organometallic material is an acetyl acetonate complex of alkaline, alkaline earth or transition metals such as lithium, cesium, sodium, copper, potassium, and strontium acetylacetonate.

3. A composition of combustible matter as recited in claim 2 wherein said organometallic material is selected from the group consisting of cesium acetylacetonate, lithium acetylacetonate, copper acetylacetonate and calcium, strontium and sodium acetylacetonate.

4. A composition of combustible matter as recited in claim 1 wherein said organic polar solvent includes high boiling point alcohol, glycol or glycol ether.

5. A composition of combustible matter as recited in claim 1 wherein said organic polar solvent includes a high boiling point alcohol selected from the group consisting of n-pentanol, n-hexananol and n-heptanol.

6. A composition of combustible matter as recited in claim 1 wherein said organic polar solvent includes glycols selected from the group consisting of diols selected from the group consisting of 1,3-propane diol, 1,3-butane diol, and 1,3-pentane diol.

7. A composition of combustible matter as recited in claim 1 wherein said hydrocarbon fuel is a low boiling hydrocarbon mixture.

8. A composition of combustible matter as recited in claim 1 wherein said hydrocarbon fuel is selected from the group consisting of a natural gas mixture selected from the group consisting of propane, butane pentane, hexane and mixtures thereof.

9. A composition of combustible matter as recited in claim 1 wherein said organic polar solvent is selected from the group consisting of a high boiling point alcohol, ethylene glycols, propylene glycols, ethylene glycol ethers and propylene glycol ethers.

10. A composition of combustible matter as recited in claim 1 wherein said hydrocarbon fuel is selected from the group consisting of synthetic waxes, animal derived waxes and plant derived waxes.

11. A composition of combustible matter as recited in claim 1 wherein said hydrocarbon fuel is selected from the group consisting of bees wax, paraffin wax, whale wax, and any other natural or synthetic wax material with a chemical formula of CH3(CH2)nCOO(CH2)mCH3, where m and n are integer numbers, that are naturally solid at ambient temperature but have a low melting point and can be melted to liquid form at elevated temperature.

12. A method of making a combustible liquid having a predetermined flame color comprising the steps of:
obtaining about 1% to about 10% wt of an organometallic material which is soluble in or miscible with an organic polar solvent;
dissolving said organometallic material in about 5% by wt to about 55% wt of an organic polar solvent; and
mixing the dissolved organometallic material and solvent with about 5% wt. to about 65% wt. of a hydrocarbon material to develop a homogenious liquid that when burned produces a flame having a predetermined color.

13. A method of making a combustible liquid as recited in claim 12 wherein said organometallic material is selected from the group consisting of lithium acetylacetonate, sodium acetylacetonate, copper acetylacetonate, cesium acetylacetonate, potassium acetylacetonate, and strontium acetylacetonate.

14. A method of making a combustible liquid as recited in claim 13 wherein said solvent is selected from the group consisting of a high boiling point alcohol, a glycol and a glycol ether.

15. A method of making a combustible liquid as recited in claim 13 wherein said hydrocarbon material is selected from the group consisting of paraffin, wax, and aliphatic or olefinic hydrocarbons such as odorless mineral spirits or petroleum naphtha.

16. A method of making a combustible liquefied gas having a predetermined flame color comprising the steps of:
obtaining about 1% by wt. to about 10% wt. of an organometallic material which is soluble in or miscible with an organic polar solvent;
dissolving said organometallic material in from about 5% by wt. to about 55% wt. of an organic polar solvent; and
mixing the dissolved organometallic material and solvent in from about 5% wt. to about 75% wt. of a low boiling point hydrocarbon mixture, or a commercially available natural gas mixture such as propane, butane pentane, hexane or a mixture thereof.

17. A method of making a combustible liquefied gas as recited in claim 16 wherein said organometallic material is selected from the group consisting of lithium acetylacetonate, sodium acetylacetonate, copper acetylacetonate, cesium acetylacetonate, potassium acetylacetonate, and strontium acetylacetonate.

18. A method of making a combustible solid having a predetermined flame color comprising the steps of:
obtaining about 1% by wt. to about 10% wt. of an organometallic material which is soluble in or miscible with an organic polar solvent;
dissolving said organometallic material in about 2% by wt. to about 20% by wt. of an organic polar solvent such as a high boiling point alcohol, an ethylene propylene glycol, or an ethylene or propylene glycol ether; and
mixing the dissolved organometallic material with from about 5% by wt. to about 95% by wt. of a synthetic, animal derived or plant derived wax such as bees wax, paraffin wax, whale wax or any other natural or synthetic wax material with a chemical formula of CH3(CH2)nCOO(CH2)mCH3, where m and n are integer numbers, that are naturally solid at ambient temperature but have a low melting point and can be melted to liquid from at elevated temperature.

19. A method of making a combustible solid as recited in claim 18 wherein said organometallic material is selected from the group consisting of lithium acetylacetonate, sodium acetylacetonate, calcium acetylacetonate, copper acetylacetonate, cesium acetylacetonate, potassium acetylacetonate, sodium acetylacetonate and strontium acetylacetonate.
